(19) United States
(12) Patent Application Publication
(10) Pub. No.: US 2012/0065844 A1
(43) Pub. Date: Mar. 15, 2012

(54) Intelligent Arming Module for a Vehicle Security System and Vehicle Security System Incorporating Intelligent Arming

(75) Inventors: Steven Metlitzky, Stirling (AU); Damian Shelton, Stirling (AU)

(73) Assignee: DYNAMCO PTY LTD, East Perth, WA (AU)

(21) Appl. No.: 13/321,170

(22) PCT Filed: May 20, 2010
(86) PCT No.: PCT/AU2010/000593

§ 371 Date: Nov. 18, 2011

(30) Foreign Application Priority Data
May 20, 2009 (AU) 2009902296

(51) Int. Cl. G06F 7/00

(52) U.S. Cl. 701/45

(57) ABSTRACT

An operational status module 11 for a vehicle security system is disclosed. A security system processor in the security system interacts with the operational status module 11 to determine if the security system should arm when an arm command is processed by the security system. The operational status module 11 has an audio or vibration sensing transducer 13 arranged to pick up a signal indicative of operation of a vehicle. The transducer 13 is connected to circuitry 15 providing a digital representation of the signal sensed by the transducer 13 which is received by a processor 21. The processor 21 will issue a control signal to cause an overriding of an arm command if the digital representation contains a signal representative of vehicle or engine vibration within a window period.

### FIELD OF THE INVENTION

This invention relates to security systems and in particular to security systems for motor vehicles.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

One of the key functions of a vehicle security system with an alarm or siren is to ensure that the system does not arm while the vehicle is going or the engine is running. Arming whilst the engine is running and/or the vehicle is moving would cause the alarm to sound either via the security system siren or connected vehicle horn alarm, which is a) dangerous and b) illegal depending on the laws of that state or country.

To prevent this occurring, the security system is typically connected to the ignition system or ignition wire. As this wire is only live when the ignition is switched on (or grounded when switched on depending upon the ignition system design, although live when switched on is most typical), the security system can readily monitor the vehicle's ignition system state and use this state to determine whether the engine is running or not. Using the ignition wire or ignition system state, the security system can then prevent itself arming, whether that arm signal was originally generated automatically (auto-arm) or by a direct action of the user, such as pressing a remote.

The downside of this method is the additional complexity and cost of installation required for the vehicle security system that most commonly requires connection to the vehicle ignition wire. Connection to this vehicle ignition system or wire is typically difficult and labour intensive to achieve, especially in newer vehicle where access through the firewall between the engine and passenger compartment is very limited.

Throughout the specification unless the context requires otherwise, the word “comprise” or variations such as “comprises” or “comprising”, will be understood to imply the inclusion of a stated integer or group of integers but not the exclusion of any other integer or group of integers.

Throughout the specification unless the context requires otherwise, the word “include” or variations such as “includes” or “including”, will be understood to imply the inclusion of a stated integer or group of integers but not the exclusion of any other integer or group of integers.

### DISCLOSURE OF THE INVENTION

This invention provides an alternative arrangement that obviates the need to access an ignition system wire when installing a vehicle security system as an after-market installation. This invention achieves the function of monitoring the operational status of a motor vehicle without any connection to the vehicle's ignition system. Obviating the need to connect to the vehicle's ignition system, either directly wired or through a separate module communicating wirelessly with the security system, reduces installation time, complexity and cost.

The invention resides in the utilisation of an in-built shock sensor typically housed within the siren itself but could be housed separately, that is monitored by a small CPU (computer chip) typically co-located with the shock sensor inside the siren, to assess whether the vehicle's engine is running. This is achieved by software algorithms inside the vehicle security system's CPU that log and analyse the pattern of shock and vibration. This can be done either in real-time, by looking for a specific pattern and rate of pulses over time, or in another arrangement by logging this data and then matching these to typical, predetermined engine idling and rev patterns to determine whether the engine is indeed running or not. This information can then be used by the security system to reliably tell whether to allow the system to arm, whether the arm instruction was automatically generated (auto-arming) or manually by the user interacting with the security system, such as arming the system via a remote without the need for any direct or indirect connection to the vehicle's ignition system.

While the shock sensor is most commonly co-located with the CPU in the main siren module, the shock/vibration sensor may actually be contained in a separate module that communicates a signal to the main security system CPU and system logic via either a wired or wireless connection.

The vibration/shock sensor is an s-transducer with a spring and weight but the vibration sensor could be any electro-mechanical device that provides the system with shock/vibration data from which a digital pulse pattern can be derived and analysed, compared and distinguished, so that a determination can be made as to whether the engine is running and use this determination as a decision basis for whether to allow the security system to arm or not.

In real-time mode, the software looks for a certain rate of pulses in a given timeframe. In a log and compare mode, the system takes the analog voltage pulses from the vibration sensor, translates these into digital pulses and stores these in memory as a pattern vs time ie voltage levels vs time and then uses a software algorithm to compare the pattern observed in real time with a set of stored patterns to determine whether it qualifies as ‘vehicle running’ or not.

In accordance with the invention there is provided an operational status module for a vehicle security system, where a security system processor in said security system interacts with said operational status module to determine if said security system should arm when an arm command is processed by said security system, said operational status module having an audio or vibration sensing transducer arranged to pick up a signal indicative of operation of a vehicle, said transducer being connected to circuitry providing a digital representation of the signal sensed by said transducer, said circuitry including a processor arranged to receive said digital representation, said processor interacting with said security system processor to control arming of said security system based on analysis of said digital representation, where said operational status module will issue a control signal to cause an overriding of an arm command if said digital representation contains a signal representative of vehicle or engine vibration within a window period.

Preferably the window period is at least 40 milliseconds.

Preferably the window period is from 50 milliseconds to 100 milliseconds.

Preferably the signal representative of noise equates to more than one pulse occurring within any window period of 50 milliseconds. There may be more than two, three, four, five, six, seven, eight, or nine pulses occurring within any window period of 50 milliseconds.

Preferably the signal representative of noise equates to about ten pulses occurring within any window period of 50 milliseconds.

Preferably said audio or vibration sensing transducer is a vibration sensing transducer.

Preferably said vibration sensing transducer is a piezo electric transducer.

Preferably said vibration sensing transducer is a piezo electric transducer mechanically coupled to a spring at one end thereof, said spring having a weight at the other end. With such an arrangement, the weight will set up a vibration in the spring, in response to detected vibration, which vibration will also be detected and produce a signal from the piezo electric transducer, in addition to vibration which directly impinges said piezo electric transducer.

Preferably said vibration sensing transducer is arranged to pick up signals indicative of operation of the vehicle by being in mechanical connection with a housing in which said module is installed. In turn the module would be mounted in the vehicle in mechanical connection with metalwork of the vehicle, so that shock and vibration eminating from the running internal combustion engine is picked up. The mechanical connection within the housing of the module may be as simple as a non insulating mounting within the housing which mounts a printed circuit board on which the transducer is mounted and soldered.

Also in accordance with the invention there is provided an operational status module for a vehicle security system, where a security system processor in said security system interacts with said operational status module to determine if said security system should arm when an arm command is processed by said security system, said operational status module having an audio or vibration sensing transducer arranged to pick up signals indicative of operation of a vehicle, said transducer being connected to circuitry providing a digital representation of the signal sensed by said transducer, said circuitry including a processor interfaced with a memory in which is stored a plurality of digital patterns representative of signals expected to be sensed by said transducer corresponding to various operational status conditions of said vehicle, said processor being arranged to perform a comparison of the digital representation of the signal sensed by said transducer with the plurality of digital patterns representative of signals expected to be sensed by said transducer corresponding to various operational status conditions of said vehicle, said processor interacting with said security system processor to control arming of said security system based on the outcome of the comparison.

Preferably said circuitry comprises an amplifier which produces an analog output signal which is fed to an analog to digital converter, said analog to digital converter providing a digital representation of the signal sensed by said transducer.

Preferably said vehicle security system queries said operational status module when an arm command is processed by said security system. With this arrangement, the vehicle security system will issue a signal to said operational status module when processing an arm command, and subsequently the processor of said operational status module will issue a signal to said security system. There are a number of ways this can be achieved, either the operational status module issuing a signal if it is permissible for the security system to arm, or issuing a signal if it is not permissible for the security system to arm. The signal could be a logical high or a logical low, or may be a binary coded serial signal.

Alternatively said operational status module continually updates said vehicle security system based on the outcome of the comparison, so said security system can immediately process an arm command based on the most recent outcome of the comparison. In this manner the security system does not query the operational status module when an arm command is received, but rather has up to date data at hand from said operational status module, on which a decision can be made.

The arm command may be a manual arm command initiated by a user pressing a button on a remote fob, or may be an automatic arm command produced by a circuit interfaced with a timer, which periodically polls the security system to prompt the security system to arm (auto-arming).

Preferably said operational status module has a learn mode, where sounds/vibrations data indicative of operation of the vehicle may be stored in said memory.

Preferably said amplifier has an automatic gain control with predetermined maximum and minimum gain values, to bring the analog output signal to within predetermined limits to match the requirements of said analog to digital converter.

Preferably said amplifier includes filtering so that only the most relevant frequencies indicative of vehicle operation are processed for comparison.

Preferably the filtering is a low pass filter with a 6 dB corner occurring at up to 500 Hz.

Preferably the filtering is a low pass filter with a 6 dB corner occurring at up to 400 Hz.

Preferably the filtering is a low pass filter with a 6 dB corner occurring at up to 300 Hz.

Preferably the filtering is a low pass filter with a 6 dB corner occurring at up to 250 Hz.

Preferably the filtering is a low pass filter with a 6 dB corner occurring at up to 200 Hz.

Preferably the filtering is a low pass filter with a 6 dB corner occurring at up to 150 Hz.

Preferably the filtering is a low pass filter with a 6 dB corner occurring at up to 100 Hz.

Alternatively the filtering is a low pass filter with a 12 dB corner occurring at up to 500 Hz.

Preferably the filtering is a low pass filter with a 12 dB corner occurring at up to 400 Hz.

Preferably the filtering is a low pass filter with a 12 dB corner occurring at up to 300 Hz.

Preferably the filtering is a low pass filter with a 12 dB corner occurring at up to 250 Hz.

Preferably the filtering is a low pass filter with a 12 dB corner occurring at up to 200 Hz.

Preferably the filtering is a low pass filter with a 12 dB corner occurring at up to 150 Hz.

Preferably the filtering is a low pass filter with a 12 dB corner occurring at up to 100 Hz.

### BRIEF DESCRIPTION OF THE DRAWINGS

Three preferred embodiments of the invention will now be described in the following description, made with reference to the drawings in which:

FIG. 1 is a block diagram of an operational status module according to the first embodiment;

FIG. 2 is a block diagram of an operational status module according to the second embodiment

FIG. 3 is a perspective view of part of a circuit board and shock/vibration sensor utilised in all of the embodiments

FIG. 4 is a side view of part of part of a circuit board and shock/vibration sensor shown in FIG. 3 and

FIG. 5 is a block diagram of an operational status module according to the third embodiment.

### BEST MODE(S) FOR CARRYING OUT THE INVENTION

All three embodiments are an operational status module 11, which is intended to be co-housed with a sounding device such as an alarm siren, which is typically located in the engine bay of a vehicle. The operational status module 11 is interfaced with a security system (as is the sounding device). The security system will typically have a microprocessor or microcontroller, which controls operation of the vehicle security system. Vehicle security systems have a range of features, depending upon requirements. For example some may arm in response to a user locking the vehicle with a remote key, which actuates central locking motors, while others may auto-arm after a predetermined period of the vehicle not being operated (auto-arming).

The operational status modules 11 of the first two embodiments have an audio or vibration sensing transducer/shock/vibration transducer in the form of an s-transducer with a spring and weight 13 connected to an amplifier 15 which provides a processed analog signal 17 to an analog to digital converter 19. The output of the analog to digital converter 19 feeds to a microprocessor 21. A memory module 23 interfaces with the microprocessor 21 and contains a library of digital signatures or parameter data corresponding to a range of signals that would be output by the analog to digital converter 19 and which are indicative of the vehicle being in operation. The microprocessor 21 performs a comparison of the current output of the analog to digital converter 19 with the digital signals stored in memory module 23, to determine the operational status of the vehicle.

The first embodiment shown in FIG. 1 has an input 25, which receives a query from the security system when the security system is to arm. In response the microprocessor 21 will send a signal 27 to the security system if the comparison is true, in response to which the security system will disallow the arm command. In an alternative embodiment, the microprocessor 21 will send a signal to the security system if the comparison is false, in response to which the security system will allow the arm command. In either case, the security system will not arm if the vehicle is in operation.

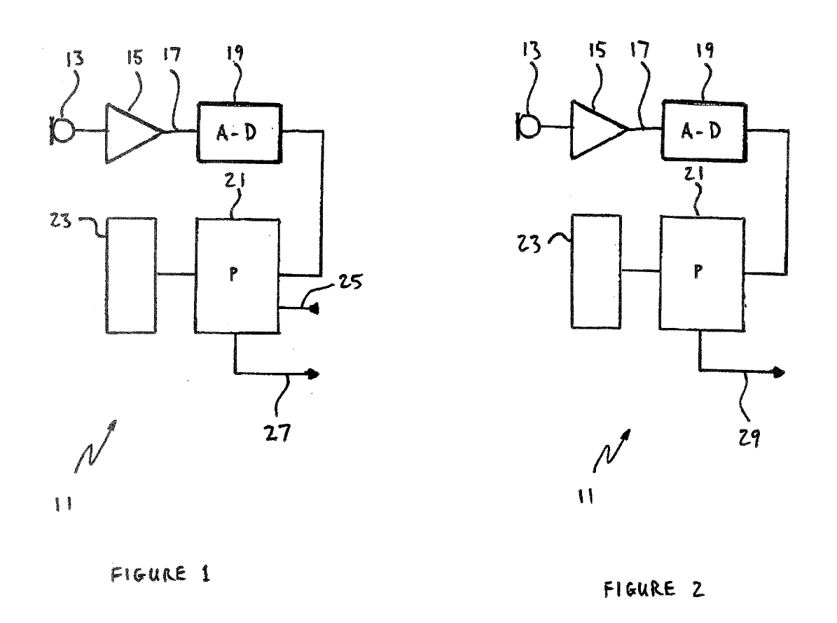

The second embodiment shown in FIG. 2 performs periodic comparisons as discussed above. The microprocessor 21 has an output 29 that remains high for a second predetermined period if the most recent comparison is true. The output 29 is interfaced with the security system, so that the security system can arm on call or according to schedule, only if the output is low, indicating the vehicle is not in operation. It will be understood that polarities may be reversed, without departing from the invention (ie true=output 29 is low).

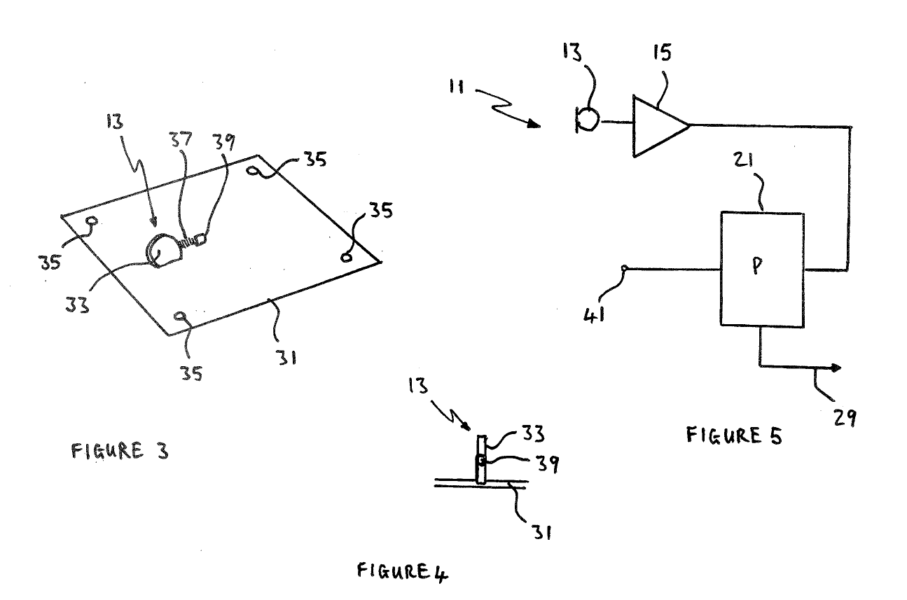

Referring to FIGS. 3 and 4, the s-transducer with a spring and weight 13 is shown mounted on a printed circuit board 31. The s-transducer with a spring and weight 13 comprises separately, a piezo electric transducer 33 which is mounted with its peripheral edge contacting the printed circuit board 31 located in a slot therein excavated by a router, and soldered to the printed circuit board 31. The printed circuit board 31 has apertures 35 by which it is mounted to stand-offs (not shown) in a housing (also not shown), housing the operational status module 11. Mounted to the piezo electric transducer 33 on an edge normal to that contacting the printed circuit board 31, is one end of a small coil spring 37 with a weight 39 attached to the other end.

Vibration is transmitted to the printed circuit board via the standoffs secured in the apertures 35, and in turn is sensed by the piezo electric transducer 33.

In use, as vibration is applied to the car, the weight 39 remains stationary while the piezo electric transducer 33 vibrates in sympathy with the vehicle. This generates a very low voltage. If the vibration is great enough, the coil spring 37 will eventually transfer movement to the weight 39 which will then continue to move for a short time after the vibration from the car ceases. This difference in vectors will also produce as very small voltage. Referring to FIG. 5, which is a block schematic of the circuit of the third embodiment, the resultant voltages from the transducer 13 are amplified by the amplifier 15 and fed to the microprocessor 21 transmitted to the digital input of the controllers CPU. In this arrangement, the amplifier is driven to clipping, effectively providing an analog to digital conversion function, sufficient for the purposes of the third embodiment. The microprocessor 21 has an input 41 which is arranged to receive a signal from the security system when an arm command is to be processed by the security system.

If any vibration is detected within the 1st 50 mS of receiving a signal from the security system when an arm command is to be processed, the microprocessor 21 sends an output signal 29 to the security system, which is configured to then ignore the command to arm. In such circumstances, the microprocessor 21 determines that the engine is most likely running, and/or the car is moving. If an output signal 29 is sent, the security system can be configured to issue a short chirp through the siren speaker of another audio transducer, so that if the arm command was issued as a result of the user pressing a remote arm button, the user will be alerted to the fact that the security system is not armed, so the user may chose to try again to arm the security system.

These vibrations which are detected emanate from all interaction with a vehicle, including but not limited to; engine running, rough road surface, accelerating, braking, passengers moving within vehicle and others.

It should be appreciated that the scope of the invention is not limited to the particular embodiments described herein, and that changes may be made without departing from the spirit and scope of the invention.

1. An operational status module for a vehicle security system, where a security system processor in said security system interacts with said operational status module to determine if said security system should arm when an arm command is processed by said security system, said operational status module having an audio or vibration sensing transducer arranged to pick up a signal indicative of operation of a vehicle, said transducer being connected to circuitry providing a digital representation of the signal sensed by said transducer, said circuitry including a processor arranged to receive said digital representation, said processor interacting with said security system processor to control arming of said security system based on analysis of said digital representation, where said operational status module will issue a control signal to cause an overriding of an arm command if said digital representation contains a signal representative of vehicle or engine vibration within a window period.

2. An operational status module for a vehicle security system as claimed in claim 1 wherein the window period is at least 40 milliseconds.

3. An operational status module for a vehicle security system as claimed in claim 1 wherein the window period is from 50 milliseconds to 100 milliseconds.

4. An operational status module for a vehicle security system as claimed in claim 1 wherein the signal representative of noise equates to more than one pulse occurring within any window period of 50 milliseconds.

5. An operational status module for a vehicle security system as claimed in claim 1 any one of the preceding claims wherein the signal representative of noise equates to about ten pulses occurring within any window period of 50 milliseconds.

6. An operational status module for a vehicle security system as claimed in claim 1 wherein said audio or vibration sensing transducer is a vibration sensing transducer.

7. An operational status module for a vehicle security system as claimed in claim 6 wherein said vibration sensing transducer is a piezo electric transducer.

8. An operational status module for a vehicle security system as claimed in claim 6 wherein said vibration sensing transducer is a piezo electric transducer mechanically coupled to a spring at one end thereof, said spring having a weight at the other end.

9. An operational status module for a vehicle security system as claimed in claim 1 wherein said vibration sensing transducer is arranged to pick up signals indicative of operation of the vehicle by being in mechanical connection with a housing in which said module is installed.

10. An operational status module for a vehicle security system, where a security system processor in said security system interacts with said operational status module to determine if said security system should arm when an arm command is processed by said security system, said operational status module having an audio or vibration sensing transducer arranged to pick up signals indicative of operation of a vehicle, said transducer being connected to circuitry providing a digital representation of the signal sensed by said transducer, said circuitry including a processor interfaced with a memory in which is stored a plurality of digital patterns representative of signals expected to be sensed by said transducer corresponding to various operational status conditions of said vehicle, said processor being arranged to perform a comparison of the digital representation of the signal sensed by said transducer with the plurality of digital patterns representative of signals expected to be sensed by said transducer corresponding to various operational status conditions of said vehicle, said processor interacting with said security system processor to control arming of said security system based on the outcome of the comparison.

11. An operational status module for a vehicle security system as claimed in claim 10 wherein said circuitry comprises an amplifier which produces an analog output signal which is fed to an analog to digital converter, said analog to digital converter providing a digital representation of the signal sensed by said transducer.

12. An operational status module for a vehicle security system as claimed in claim 10 wherein in operation, said vehicle security system queries said operational status module when an arm command is processed by said security system.

13. An operational status module for a vehicle security system as claimed in claim 10 wherein said operational status module continually updates said vehicle security system based on the outcome of the comparison, so said security system can immediately process an arm command based on the most recent outcome of the comparison.

14. An operational status module for a vehicle security system as claimed in claim 10 wherein said operational status module has a learn mode, where sounds/vibrations data indicative of operation of the vehicle may be stored in said memory.

15. An operational status module for a vehicle security system as claimed in claim 11 wherein said amplifier has an automatic gain control with predetermined maximum and minimum gain values, to bring the analog output signal to within predetermined limits to match the requirements of said analog to digital converter.

16. An operational status module for a vehicle security system as claimed in claim 11 wherein said amplifier includes filtering so that only the most relevant frequencies indicative of vehicle operation are processed for comparison.

17. A vehicle security system for a motor vehicle incorporating an operational status module as claimed in claim 1.
